(19) United States
(12) Patent Application Publication
(10) Pub. No.: US 2006/0012551 A1
(43) Pub. Date: Jan. 19, 2006

(54) Liquid crystal display with an image flicker eliminaiton function applied when power-on and an operation method of the same

(75) Inventors: Chia-Cheng Chiu, Jhunan Township (TW); Bo-An Chen, Tianjhong Township (TW)

Correspondence Address: BRUCE H. TROXELL;SUITE 1404, 5205 LEESBURG PIKE, FALLS CHURCH, VA, 22041, US

(73) Assignee: AU Optronics Corp.

(21) Appl. No.: 11/106,564

(22) Filed: Apr. 15, 2005

(30) Foreign Application Priority Data
Jul. 16, 2004 (TW) 93121342

(51) Int. Cl. G09G 3/36

(52) U.S. Cl. 345/87

(57) ABSTRACT

A liquid crystal display (LCD) with an image flicker eliminating function applied when power-on comprising an LCD panel, a panel power supplier, an image control unit, and a timing control unit is provided. The panel power supplier offers the power needed for starting the LCD panel. The image control unit controls the image input into the LCD panel. The timing control unit connects to the panel power supplier and the image control unit to dominate the operating sequence. An operation method of the LCD is to provide a designed pattern with a predetermined length at a predetermined time to the LCD panel, so as to generate enough driving electric field to charge LC capacitors in the LCD panel.

### FIELD OF THE INVENTION

The present invention relates to a method of improving displaying quality of a liquid crystal display. More particularly, the present invention relates to a method of avoiding flickers and residual images generating at the time of turning on and turning off the liquid crystal display.

### BACKGROUND OF THE INVENTION

A liquid crystal display takes the place of a cathode ray tube (CRT) due to its features of compact, light, thin, small and radiation-free. The LCD technology is widely applied on high-resolution digital televisions, laptops, personal digital assistants, notebooks, digital cameras and mobile phones.

Referring to FIG. 1, a single pixel 1 includes a thin film transistor (TFT) 2 and a liquid crystal (LC) capacitor 3. The source of the TFT 2 is electrically connected to the data line 4, and the gate of the TFT 2 is electrically connected to the scan line 5. An electrode layer of the LC capacitor 3 is connected with the drain of the TFT 2. The other electrode layer of the LC capacitor 3 is supplied with a common voltage (V_{com}).

The LC capacitor 3 comprises a common electrode (not shown herein), a pixel electrode (not shown herein) and an LC layer (not shown herein), wherein the LC layer is sandwiched between the common electrode and the pixel electrode. The common electrode is supplied with the V_{com}, and the pixel electrode is fed with an operation voltage (Vₒ). The voltage difference between the V_{com} and the Vₒ generates an electrical field capable of driving LC molecules within the LC layer to align. Generally speaking, certain properties of the LC molecules, e.g. alignments responsive to the electrical field, will be ruined when the polarity of the voltage is fixed. To avoid the phenomenon, accordingly, different polarities of the Vₒ, i.e. the alternating current (AC), are applied to drive the LC molecules.

As shown in FIG. 2, when an LCD displays a static image, the Vₒ applied onto the pixel electrode exhibits positive cycle and negative cycle by turns. The positive cycle indicates the Vₒ is greater than the V_{com}, whereas the negative cycle means the Vₒ is smaller than the V_{com}. To display the static image, the absolute value of the voltage difference exists between the Vₒ and V_{com} has to remain constant. That is, although alignments of the LC molecules alter responsively to the positive cycle and the negative cycle, the transparency of the LC layer will be consistent if the intensity of the electric field generated from the voltage difference is fixed.

Referring to FIG. 3, when the real common voltage (V_{com′}) shifts from the ideal common voltage (V_{com}), the absolute value of the voltage difference between the V_{com′} and Vₒ will change correspondingly. For example, when the positive bias is occurring, the absolute value of the voltage difference between the V_{com′} and Vₒ respectively reduces and increase in the positive cycle region and the negative cycle region. In this case, the intensity of the electric field within the LC layer varies with fluctuations of the absolute value. As a result, the transparency of the LC layer cannot maintain consistent. Image flickers thus generate.

It is noted that electrical charges usually remains within the LC capacitor while powering off the display. Accordingly, residual images are generated on the display at the time of turning the display off. Referring to FIG. 1, When the electrical charges within the LC capacitor is not released completely, the bias, e.g. DC-bias, will occur and the V_{com} will be influenced, resulting in the image flickers described above on the LCD panel. In other words, if the electrical charges cannot be eliminated before restarting the display, the image flickers will generate at the time of restarting the LCD panel.

As concluded, the residual charge within the LC layer is needed to be released to avoid the residual images and flickers.

### SUMMARY OF THE INVENTION

The present invention provides an LCD and a method to rapidly charge the LC capacitor when turning on the LCD.

The LCD with functions of eliminating flickers and residual images comprises an LCD panel, a power supply, an image control unit and a timing control unit. The LCD panel having a plurality of LC capacitors therein is used to display image. The power supply provides power to the LCD panel. The image control unit is used to control image signals inputted into the LCD panel. The timing control unit connected between the LCD panel and the image control unit controls the operational timing of the image control unit and the LCD panel. While powering on the LCD, the timing control unit notifies the LCD panel at a first predetermined timing to activate, and then notifies the image control unit at a second predetermined timing to provide a designed pattern to the LCD panel for rapidly charging the LC capacitor.

The method of preventing the generation of the flickers and the residual images comprises steps of turning on the power supply of the LCD, starting the LCD panel at the first predetermined timing after turning the power supply on, and providing a designed pattern to the LCD panel at the second predetermined timing for rapidly charging the LC capacitor. The LC layer within the LC capacitor is activated through the rapid charging.

### BRIEF DESCRIPTION OF THE DRAWINGS

The foregoing aspects and many of the attendant advantages of this invention will become more readily appreciated and understood by referencing the following detailed description in conjunction with the accompanying drawings, wherein:

FIG. 1 is a typically circuit diagram of a single pixel of an LCD.

FIG. 2 shows an oscillogram of operation voltage when a static image is displayed on the LCD.

FIG. 3 shows an oscillogram of operation voltage when flickers occurs on the LCD.

FIG. 4 shows the LCD in accordance with the present invention.

FIG. 5 shows a flowchart of a preferred method to avoid flickers occurring at the time of restarting the LCD in accordance with the present invention.

FIG. 6 shows an oscillogram regarding panel power and image signal corresponding to FIG. 5.

FIG. 7 shows a flowchart of another method to avoid flickers occurring at the time of restarting the LCD in accordance with the present invention.

FIG. 8 shows an oscillogram regarding panel power and image signal corresponding to FIG. 7.

FIG. 9A is an oscillogram showing the variation of operation voltage when not providing a designed pattern to an LCD panel in accordance with the present invention.

FIG. 9B is an oscillogram showing the variation of operation voltage when providing a designed pattern to the LCD panel in accordance with the present invention.

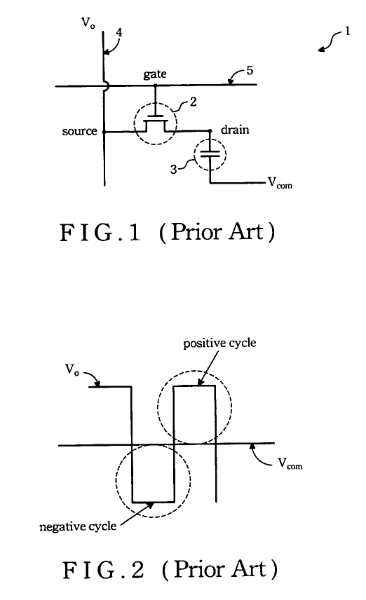

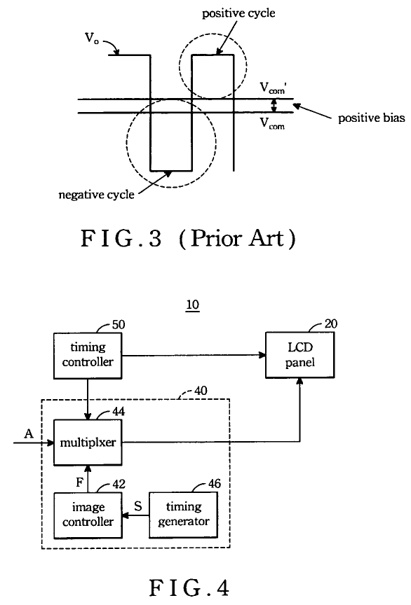

### DESCRIPTION OF THE PERFERRED EMBODIMENTS

The invention discloses a liquid crystal display (LCD) and a method of improving displaying quality of the LCD. The present invention is now described in detail below.

Referring to FIG. 4, a diagram of a preferred embodiment of the LCD 10 is shown. The LCD 10 comprises an LCD panel 20, an image control unit 40 and a timing control unit 50. The LCD panel 20 having a plurality of LC capacitors (not shown herein) is used to display images. The image control unit 40 connecting with the LCD panel 20 controls signals of images and transmits the signals to drivers of the LCD panel 20, such as source drive and gate driver, for generating images on the LCD panel 20. The timing control unit 50 connecting with the LCD panel 20 and image control unit 40 controls the operational sequence and timing of charging and discharging the LC capacitors.

As shown in the figure, the image control unit 40 includes an image generator 42, a multiplexer 44 and a timing signal generator 46. The image generator 42 is used to produce a designed pattern F. The multiplexer 44 connects with the image generator 42 and the timing control unit 50, receiving the designed pattern F and an inputted normal image A. Subsequently, the multiplexer 44 selectively transmitting one of the designed pattern F and the normal image A to the LCD panel 20. The timing signal generator 46 connecting with the image generator 42 provides a timing signal S of the designed pattern F, wherein the timing signal S is used to control scanning speed and displaying duration of the designed pattern F on the LCD panel 20.

At the time of turning off the LCD 10, the electrical charges usually remain within the LC capacitor of the LC panel 20. The remaining electrical charges result in temporary flickers while restarting the LCD 10. Accordingly, if the LC capacitor can be rapidly charged for activating the LC layer when restarting the LCD 10, the flickers will be effectively eliminated.

To charge the LC capacitor, the image control unit 40 transmits signals of the designed pattern F to the LCD panel 20 after powering on the LCD 10. The designed pattern F provides adequate electrical field to the LC capacitor of the LCD panel 20, thus charging the LC capacitor in a short period of time. In one preferred embodiment of the present invention, the intensity of the electrical field provided by the designed pattern F is at least 90% of the intensity of maximal electrical field originally set to drive the LC molecules within the LC capacitor. In another embodiment, the intensity of the electrical field provided by the designed patterns for driving LC molecules within the LC layer is equal to maximal intensity of the electrical field originally set to drive the LC molecules. For example, in a 8-bits-per-pixel conventional LCD panel, the maximal electrical field indicates a driving voltage at the value of 255. Yet the intensity of the electrical field provided by the designed pattern F usually varies according to the types of LCDs.

For ensuring the complete activation of the LC molecules within the LC capacitor, the length of the designed image F ranges from 1 to 100 predetermined frames or about 10 ms to 1000 ms. It is noted that the designed pattern F varies with types of LCD panels. For example, when the LCD panel 20 is a twisted nematic (TN) LCD panel, the designed pattern F used to rapidly charge the LC capacitors is substantially a white image. While the LCD panel 20 is a multi-domain vertical alignment (MVA) LCD panel or an in-plane switching (IPS) LCD panel, the designed pattern F is substantially a black image.

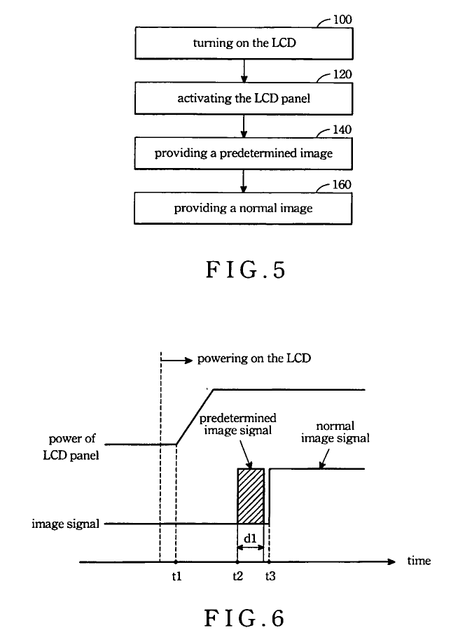

FIG. 5 shows a flowchart of a preferred method to rapidly charge the LC capacitor. Descriptions of FIG. 5 are simultaneously referred to FIG. 4 and FIG. 6. As shown in FIG. 5, the power of the LCD is turned on firstly (operation 100). Thereafter, the timing control unit 50 notifies the LCD panel 20 at a first predetermined timing t1 to actuate (operation 120). The timing control unit 50 then notifies the multiplexer 44 of the image control unit 40 at a second predetermined timing t2 to transmit the signals the designed pattern F to the LCD panel 20 for rapidly charging the LC layer (operation 140). After displaying the designed pattern F on the LCD panel 20, the timing control unit 50 notifies the multiplexer 44 of the image control unit 40 at a third predetermined timing t3 to transmit signals of the normal image A to the LCD panel 20 (operation 160), thus initiating the usual operation of the LCD panel 20. In a preferred embodiment of the present invention, the first predetermined timing t1 is set at 100 ms at latest after turning on the LCD. In addition, the length of the designed pattern F (d1) is between 20 ms and 100 ms. Further, the duration between the second predetermined timing t2 and the third predetermined timing t3 is equal to the length of the designed pattern F (d1). In other embodiments, these parameters, i.e. t1, t2, t3 and d1, vary with different designs of LCDs.

In the embodiment, it is the timing control unit 50 that controls and notifies the multiplexer 44 to transmit the signals of the normal image A to the LCD panel 20. In another embodiment of the present invention, the multiplexer 44 can directly detect an ending signal generated when the display of the designed pattern F has been accomplished. Once the ending signal is detected, the multiplexer 44 switches the signals of the designed pattern F to the signals of the normal image A, and then transmits the signals of the normal image A to the LCD panel 20.

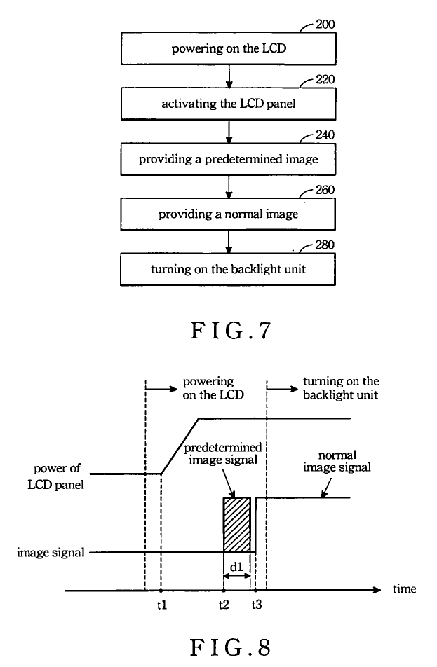

The embodiments illustrated above are applied to a reflective LCD. Referring to FIG. 7 and FIG. 8, other embodiments applied to a transmissive or a transflective LCD are disclosed herein. After powering on the LCD (operation 200), the timing control unit 50 notifies the LCD panel 20 at a first predetermined timing t1 to actuate (operation 220). The timing control unit 50 then notifies the multiplexer 44 of the image control unit 40 at a second predetermined timing t2 to provide the signals of the designed pattern F to the LCD panel 20 for rapidly charging the LC layer (operation 240). After displaying the designed pattern F on the LCD panel 20, the timing control unit 50 notifies the multiplexer 44 at a third predetermined timing t3 to transmit the signals of the normal image A to the LCD panel 20 (operation 260), thus initiating the usual operation of the LCD panel 20. Subsequently, a backlight unit of the transmissive or the transflective LCD is turned on (operation 280). The timing of turning on the backlight unit is preferably set at 20 ms at earliest to 50 ms at latest after transmitting the signals of the normal image A to the LCD panel 20.

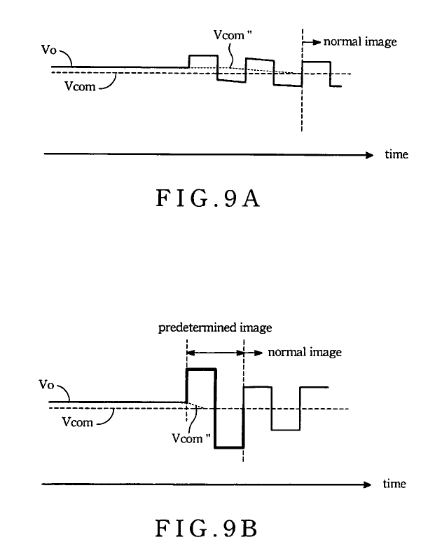

Referring to FIGS. 9A and 9B, the improvement on DC-bias via the application of the designed pattern F is shown. Vₒ means the operation voltage. The V_{com} indicates predetermined common voltage and V_{com″} is real common voltage. FIG. 9A is an oscillogram which shows the variation of V_{com″} while not providing the designed pattern F to the LCD panel 20 after powering on the LCD, whereas FIG. 9B is an oscillogram that shows the variation of V_{com″} when providing the designed pattern F to the LCD panel 20 after powering on the LCD. As shown in the figure, the designed pattern F can rapidly activate the LC molecules, thus accelerating the elimination of the DC-bias and shortening the appearance of the flickers on the LCD panel after powering on the LCD.

The present invention discloses methods of using a designed pattern F to rapidly charge LC capacitors when turning on the LCD panel. Therefore, the flickers generating at the time of turning on the LCD is eliminated and the displaying quality of the LCD is improved. Because the interference from the remaining electrical charges can be prevented, the flickers produced at the time of restarting the LCD within a short period of time are perfectly eliminated. Moreover, it is unnecessary to use other devices to have the image control unit provide a designed pattern to the LCD panel at a predetermined timing. As a result, the cost does not increase.

While the preferred embodiment of the invention has been illustrated and described, it is appreciated that modifications and variations can be made therein without departing from the spirit and scope of the invention.

What is claimed is:

1. A liquid crystal display (LCD) system, comprising:
an LCD panel having a plurality of LC capacitors;
a power supply for providing power to the LCD panel;
an image control unit for controlling signals of images inputted into the LCD panel; and
a timing control unit, connected to the image control unit and the LCD panel for controlling operational sequence of the image control unit and the LCD panel, wherein
when the LCD system is turned on, the timing control unit notifies the LCD panel at a first predetermined timing to actuate, and notifies the image control unit at a second predetermined timing to transmit a first signal of a designed pattern to the LCD panel for rapidly charging the LC capacitor.

2. The liquid crystal display system of claim 1, wherein the timing control unit further notifies the image control unit at a third predetermined timing to transmit a second signal of a normal image to the LCD panel, and duration between the second predetermined timing and the third predetermined timing is equal to length of the designed pattern.

3. The liquid crystal display system of claim 1, wherein the image control unit transmits the second signal of the normal image to the LCD panel when the display of the designed pattern has been accomplished.

4. The liquid crystal display system of claim 1, wherein a length of the designed pattern ranges from 1 to 100 frames.

5. The liquid crystal display system of claim 1, wherein the designed pattern is about 10 ms to 1000 ms in length.

6. The liquid crystal display system of claim 1, wherein intensity of electrical field provided by the designed pattern is at least 90% of the intensity of maximal electrical field originally set to drive the LC molecules within the LC capacitor.

7. The liquid crystal display system of claim 1, wherein intensity of electrical field provided by the designed patterns for driving LC molecules within the LC layer is equal to maximal intensity of the electrical field originally set to drive the LC molecules.

8. The liquid crystal display system of claim 1, further comprising a backlight unit used to provide light to the LCD, and the backlight unit is turned on after finishing the display of the designed pattern.

9. The liquid crystal display system of claim 1, wherein the image control unit comprises:
an image generator for generating the designed pattern; and
a multiplexer for receiving signals of the designed pattern and a normal image, and selectively outputting one of the signal of the designed pattern and the normal image.

10. A method of eliminating flickers generating at the time of turning on a liquid crystal display (LCD), comprising:
providing a first signal of a designed pattern with a predetermined length to an LCD panel at a predetermined timing after powering on the LCD, wherein the designed pattern corresponds to an image with maximal intensity of electrical field capable of driving LC molecules.

11. The method of claim 10, further comprising a step of turning on the LCD panel prior to the predetermined timing.

12. The method of claim 10, wherein the designed pattern is about 10 ms to 1000 ms in length.

13. The method of claim 10, wherein a length of the designed pattern ranges from 1 to 100 frames.

14. The method of claim 10, wherein the predetermined timing is set at 100 ms at latest after powering on the LCD.

15. The method of claim 10, further comprising a step of providing a second signal of a normal image to the LCD panel after displaying the designed pattern.

16. The method of claim 14, further comprising a step of turning on a backlight unit within 50 ms after providing the second signal of the normal image.

17. A method of eliminating flickers generating at the time of turning on a liquid crystal display (LCD), wherein the LCD includes an LCD panel with a plurality of LC capacitors, the method comprising:
a) turning on a power of the LCD;
b) starting the LCD panel at a first predetermined timing; and
c) providing a designed pattern to the LCD panel at a second predetermined timing for rapidly charging the LC capacitors, thus activating an LC layer within the LC capacitors.

18. The method of claim 17, further comprising a step of providing a normal image to the LCD panel at a third predetermined timing after powering on the LCD.

19. The method of claim 18, further comprising a step of turning on a backlight unit of the LCD after providing the normal image to the LCD panel.

20. The method of claim 17, wherein the designed pattern is a black image when the LCD panel is a twisted nematic (TN) LCD panel.

21. The method of claim 17, wherein the designed pattern is a white image when the LCD panel is a multi-domain vertical alignment (MVA) LCD panel.

22. The method of claim 17, wherein the designed pattern is a white image when the LCD panel is an in-plane switching (IPS) LCD panel.

23. The method of claim 17, further comprising a step of providing the normal image to the LCD panel when the display of the designed pattern has been accomplished.
